(19) United States
(12) Patent Application Publication
(10) Pub. No.: US 2017/0008791 A1
(43) Pub. Date: Jan. 12, 2017

(54) FORMING APPARATUS AND FORMING METHOD USING THE SAME

(71) Applicant: SAMSUNG ELECTRONICS CO., LTD., Suwon-si (KR)

(72) Inventors: Yong Ha KIM, Suwon-si (KR); Kyoung San KIM, Suwon-si (KR); Jung Kyu PARK, Yongin-si (KR); Sung Chan UH, Yongin-si (KR); Dae Ung YEOM, Suwon-si (KR); Seung Hwan JUNG, Seoul (KR); Won Seok CHUNG, Suwon-si (KR); Hyeon Cheol JEONG, Seoul (KR); Young Kyong JO, Suwon-si (KR); Hong Ick CHAE, Hwaseong-si (KR)

(73) Assignee: SAMSUNG ELECTRONICS CO., LTD., Suwon-si (KR)

(21) Appl. No.: 15/193,448

(22) Filed: Jun. 27, 2016

(30) Foreign Application Priority Data
Jul. 10, 2015 (KR) 10-2015-0098282

(51) Int. Cl. C03B 11/12; C03B 11/04; C03B 11/08

(52) U.S. Cl. CPC C03B 11/122; C03B 11/08; C03B 11/04; C03B 2215/50

(57) ABSTRACT

Provided are a forming apparatus for forming a part of a flat panel-shaped glass in a curved surface by selectively heating only a formation part, and a forming method using the same. The forming apparatus includes a transfer device configured to transfer material having a flat panel shape and a curved surface forming device configured to form at least one part of the material in a curved surface, wherein the curved surface forming device includes a forming mold on which the material is seated, a heating unit configured to heat the at least one part of the material by laser light, and a jig unit configured to form the at least one part of the material heated by laser light in a curved surface.

### CROSS-REFERENCE TO RELATED APPLICATION

This application claims the benefit of Korean Patent Application No. 2015-0098282, filed on Jul. 10, 2015 in the Korean Intellectual Property Office, the disclosure of which is incorporated herein by reference.

### BACKGROUND

1. Field

Embodiments of the present disclosure relate to a forming apparatus and a forming method using the method, and more particularly to a forming apparatus for forming a curved glass by selectively heating only a formation part, and a forming method using the same.

2. Description of the Related Art

Generally, electronic appliances, each of which is equipped with a touch panel (e.g., a mobile terminal, a smartphone, a tablet, etc.), have been widely used throughout the world. There are various kinds of electronic appliances ranging from a smartphone having a relatively small-sized touch panel to a large-sized tablet. A transparent window glass is mounted to the front part of each electronic appliance.

In recent times, with the development of electronic appliances having curved surfaces, user interest in a window glass having a curved surface is rapidly increasing. The curved window glass applied to various electronic appliances can improve aesthetics and can substantially enlarge a touch region of a panel.

In order to manufacture the above-mentioned curved window glass, a plate glass is thermally deformed using a mold device such that the curved window glass can be formed. That is, the curved window glass may be molded by using a high-temperature three-dimensional (3D) mold, or by applying a high-temperature radiant heat the entire area of the glass to use a dead-weight drop (or sagging).

However, according to the above-mentioned methods, heat at a forming temperature or higher is applied even to non-formation parts (planar parts), so that unexpected distortion, stain, contamination, etc. occur, and associated additional processes are needed.

### SUMMARY

Therefore, it is an aspect of the present disclosure to provide a forming apparatus for allowing some parts of a flat panel glass to have a curved surface by selectively heating only a formation part, and a forming method using the same.

It is another aspect of the present disclosure to provide a forming apparatus capable of preventing contamination in a non-formation part through a local heating using laser, and a forming method using the same.

Additional aspects of the disclosure will be set forth in part in the description which follows and, in part, will be obvious from the description, or may be learned by practice of the disclosure.

In accordance with an aspect of the present disclosure, a forming apparatus include: a transfer device configured to transfer material having a flat panel shape; and a curved surface forming device configured to form at least one part of the material in a curved surface, wherein the curved surface forming device includes: a forming mold on which the material is seated; a heating unit configured to heat the at least one part of the material by laser light; and a jig unit configured to form the at least one part of the material heated by laser light in have a curved surface.

The material may include one of glass and sapphire glass.

The forming mold may be provided to allow the material to be seated thereon to be subject to preheating, forming, and cooling.

The forming mold may include a heater configured to preheat the material.

The curved surface forming device may further include: a warming member disposed on the forming mold, and configured to maintain the material having been subject to the forming at a predetermined temperature for a predetermined period of time.

The warming member may include one of an insulation material and a heating block.

The forming mold may include: a support surface on which the material is seated; and a forming surface provided at both ends of the support surface.

The jig unit includes: a jig which includes a curved surface-shaped portion configured to form a curved surface on the at least one part of the material by pressing the at least one part of the material; and a driving device configured to move the jig.

The jig may include one pair of jigs which face each other.

The driving device may include: a first motor configured to move the jig in a first direction; a second motor configured to move the jig in a second direction perpendicular to the first direction; and a tilting portion configured to tilt the jig.

The forming apparatus may further include: a moving plate allowing the jig to be connected to the driving device so that the jig is movable.

The heating unit may include: a laser oscillator; and an optical portion configured to irradiate laser light generated from the laser oscillator onto the at least one part of the material.

The optical portion may include: a mirror configured to reflect laser light generated from the laser oscillator; and a lens allowing the laser light reflected from the mirror to be irradiated onto the material.

The heating unit may further include: a scanner configured to perform scan using the laser light generated from the laser oscillator.

The curved surface forming device may further include: a pneumatic device configured to press the at least one part of the laser-heated material using air, or configured to generate a vacuum pressure.

In accordance with another aspect of the present disclosure, a forming method include: seating material having a flat-panel shape onto a forming mold by transferring the material using a transfer unit; preheating the material seated on the forming mold; irradiating laser light to a part of the preheated material; applying external force to the part of the material onto which the laser light is irradiated; and maintaining a temperature of the material using a warming member.

The material may include one of glass and sapphire glass.

The warming member may include one of an insulation material and a heating block.

The forming mold may include: at least one flow passage and a pneumatic device which is connected to the at least one flow passage, wherein the pneumatic device allows a curved shape to be formed on the material by dead weight while adsorbing the material.

The forming method may further include: preheating another part of the material by a heater provided in the forming mold.

The forming method may further include: a jig unit configured to press the material, wherein the jig unit may include: a jig which includes a curved surface shaped portion configured to form a curved surface on the part of the material by pressing the part of the material; and a driving device configured to move the jig.

The driving device may include: a motor configured to move the jig; and a tilting portion configured to tilt the jig.

The forming method may further include: a heating unit configured to irradiate laser light onto at least one part of the material, wherein the heating unit may include: a laser oscillator; and an optical portion configured to irradiate laser light generated from the laser oscillator onto the at least one part of the material.

In accordance with another aspect of the present disclosure, a forming method includes: seating material having a flat-panel shape onto a preheated forming mold through a transfer unit; irradiating laser light onto a formation part of the material which is preheated; forming a curved shape by pressing the laser-irradiated material; and arranging a warming member at an upper side of the forming mold such that a temperature of the material is maintained.

The material may include one of glass and sapphire glass.

The warming member may include one of an insulation material and a heating block.

The forming method may further include: a jig unit configured to press the material, wherein the jig unit may include: a jig which includes a curved surface shaped portion configured to form a curved surface on a part of the material by pressing the part of the material; and a driving device configured to move the jig.

The forming method may further include: a heating unit configured to irradiate laser light onto a part of the material, wherein the heating unit may include: a laser oscillator; and an optical portion configured to irradiate laser light generated from the laser oscillator onto the part of the material.

The optical portion may include: a mirror configured to reflect laser light generated from the laser oscillator; and a lens allowing the laser light reflected from the mirror to be irradiated onto the material.

The heating unit may further include: a scanner configured to perform scan using the laser light generated from the laser oscillator.

The forming mold may further include: at least one flow passage and a pneumatic device which is connected to the at least one flow passage, wherein the pneumatic device allows a curved shape to be formed on the material by dead weight while adsorbing the material

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an electronic device having a curved glass formed by a forming apparatus according to an embodiment of the present disclosure.

FIG. 2 is a perspective view illustrating a curved glass formed by a forming apparatus according to an embodiment of the present disclosure.

FIG. 3 is a perspective view illustrating the forming apparatus according to an embodiment of the present disclosure.

FIG. 4 is a front view illustrating the forming apparatus according to an embodiment of the present disclosure.

FIG. 5 is a perspective view illustrating a transfer device of the forming apparatus according to an embodiment of the present disclosure.

FIG. 6 is a perspective view illustrating a curved surface forming device of the forming apparatus according to an embodiment of the present disclosure.

FIG. 7 is a perspective view illustrating a forming mold and a jig unit of the curved surface forming apparatus according to an embodiment of the present disclosure.

FIG. 8 is an exploded perspective view illustrating the forming mold and the jig unit according to an embodiment of the present disclosure.

FIG. 9 is a structural view illustrating a driving device of the jig unit according to an embodiment of the present disclosure.

FIG. 10 is a structural view illustrating the operation of a transfer unit according to an embodiment of the present disclosure.

FIG. 11 is a perspective view illustrating a heating unit of a curved surface forming apparatus according to an embodiment of the present disclosure.

FIG. 12 is a schematic diagram illustrating the operation of a heating unit according to an embodiment of the present disclosure.

FIG. 13 is a schematic diagram illustrating the operation of a heating unit according to another embodiment of the present disclosure.

FIGS. 14 to 17 are diagrams illustrating forming procedures of the curved surface forming apparatus according to an embodiment of the present disclosure.

FIG. 18 is a schematic diagram illustrating the operation of a transfer device discharging glass that has a curved surface resulted by the curved surface forming apparatus according to an embodiment of the present disclosure.

FIG. 19 is a perspective view illustrating a forming apparatus according to another embodiment of the present disclosure, and FIG. 20 is a front view illustrating the forming apparatus according to another embodiment of the present disclosure.

FIGS. 21 to 24 are diagrams illustrating the forming operations performed by a jig unit of the curved surface forming apparatus according to another embodiment of the present disclosure.

FIGS. 25 to 28 are schematic diagrams illustrating the forming operations performed by a jig unit according to still another embodiment of the present disclosure.

FIGS. 29 to 32 are schematic diagrams illustrating the forming operations performed by a jig unit according to still another embodiment of the present disclosure.

FIGS. 33 to 36 are schematic diagrams illustrating the forming operations performed by a jig unit according to still another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout. The embodiments can be applied to all kinds of electronic devices, each of which includes a glass having a curved surface (i.e., a curved glass). The curved glass is not flat and has a curved surface. For example, a front surface panel of a mobile electronic device may be used as the curved glass. Terms “front end”, “rear end”, “upper part,” “lower part,” “upper end,” and “lower end” are defined based on the drawings and do not limit shapes and positions of components.

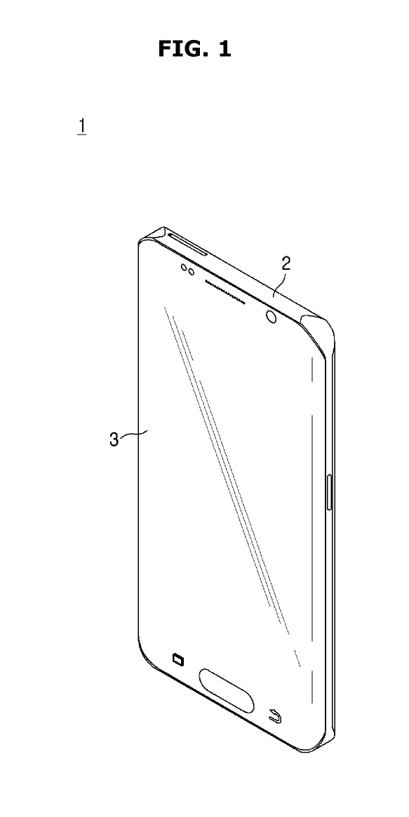

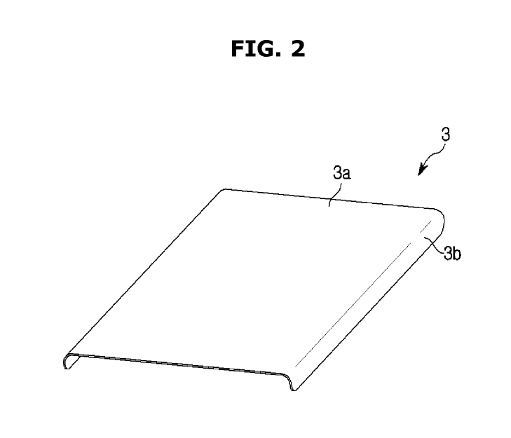

FIG. 1 is a perspective view illustrating an electronic device having a curved glass formed by a forming apparatus according to an embodiment of the present disclosure. FIG. 2 is a perspective view illustrating a curved glass formed by a forming apparatus according to an embodiment of the present disclosure.

Referring to FIGS. 1 and 2, a mobile electronic device 1 may include a case 2 and a glass 3 mounted to the front surface of the case 2.

The glass 3 mounted to the front surface of the mobile electronic device 1 may include a flat surface portion 3a having a flat surface; and a curved surface portion 3b having a curvature R at both ends of the flat surface portion 3a. Although the mobile electronic device 1 according to the embodiment has exemplarily disclosed that the curved surface portion 3b is formed at both ends of the glass 3 mounted to the front surface of the mobile electronic device 1, the scope or spirit of the present disclosure is not limited thereto. For example, the curved surface portion may also be formed at four edges of the glass mounted to the front surface of the case 2.

Meanwhile, the shape of the curved surface portion 3b of the glass 3 mounted to the front surface may improve aesthetics of the mobile electronic device 1.

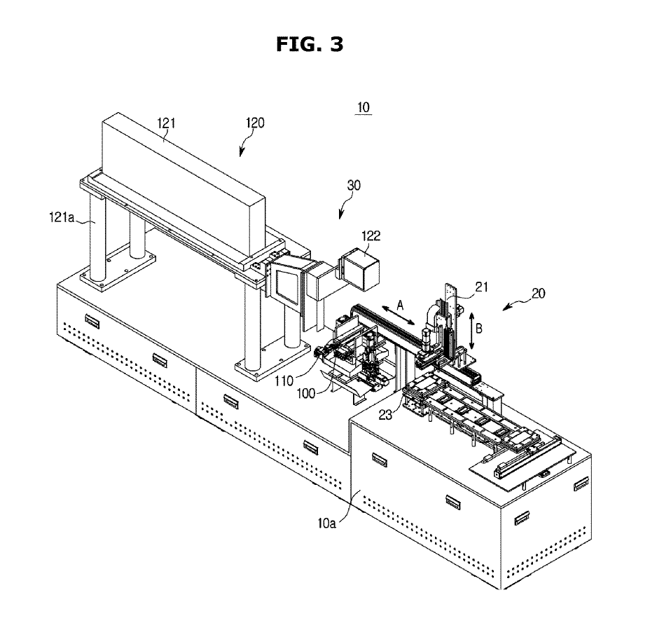

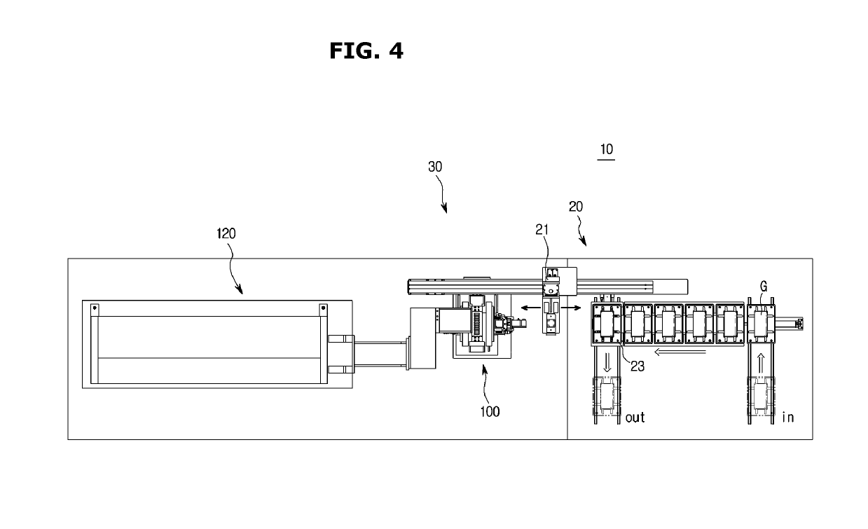

FIG. 3 is a perspective view illustrating the forming apparatus according to an embodiment of the present disclosure. FIG. 4 is a front view illustrating the forming apparatus according to an embodiment of the present disclosure.

Referring to FIGS. 3 and 4, the forming apparatus 10 configured to form the glass 3 having a curved surface may include a transfer device 20 configured to transfer a material G; and a curved surface forming device 30 configured to form a curved surface on the material transferred by the transfer device 20.

The transfer device 20 and the curved surface forming device 30 may be arranged in parallel to each other. The transfer device 20 and the curved surface forming device 30 may be arranged over a frame 10a. The transfer device 20 and the curved surface forming device 30 may be arranged in a chamber (not shown). The transfer device 20 and the curved surface forming device 30 in the chamber may be isolated from the atmosphere so as to prevent heat loss. The chamber may be filled with inert gas to prevent oxidation of the transfer device 20 and the curved surface forming device 30.

The curved surface forming device 30 may include a forming mold 100 on which the material G is seated; a heating unit 120 configured to heat at least some parts of the material G; and a jig unit 110 configured to press some parts of the locally heated part of the material G in such a manner that the some parts are formed to have a curved surface.

The material G introduced by the transfer device 20 may be formed and cooled by the curved surface forming device 30 such that the material G is formed of the glass 3 having a curved surface and then discharged by the transfer device 20.

The material G provided to have at least some part thereof formed in a curved surface may include one of glass and sapphire glass.

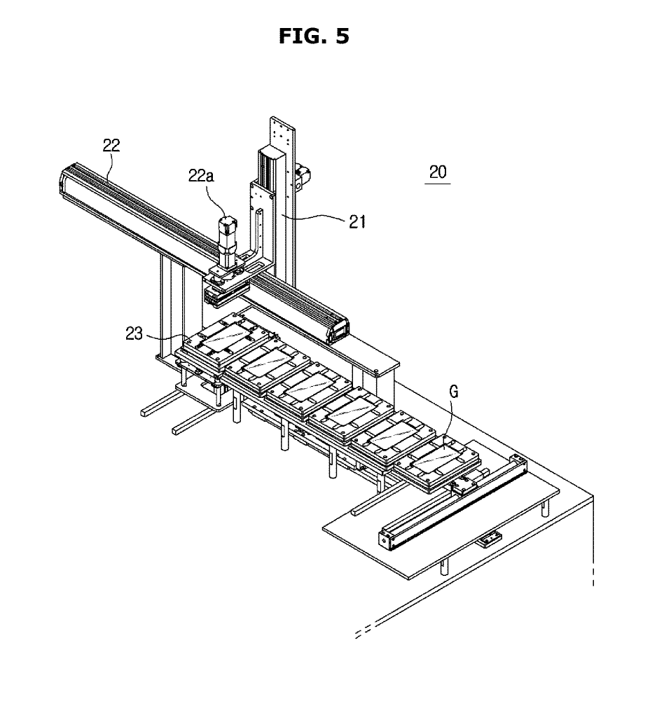

FIG. 5 is a perspective view illustrating a transfer device of the forming apparatus according to an embodiment of the present disclosure.

Referring to FIG. 5, the transfer device 20 may include a transfer mold 23 on which the material G is disposed; a pickup device 21 to pick up the material G disposed on the transfer mold 23; and a transfer rail 22 to transfer the pickup device 21.

The transfer mold 23 may include a plurality of transfer molds 23. The plurality of transfer molds 23, each of which has the material G arranged thereon, may enter a standby mode.

The pickup device 21 may pick up the material G disposed on the transfer mold 23 in a standby mode, and may supply the material G to the curved surface forming device 30. The material G picked up by the transfer mold 23 may be introduced into the forming mold 100 of the curved surface forming device 30.

The pickup device 21 may be transferred to the curved surface forming device 30 through the transfer rail 22. The transfer rail 22 may be elongated in a first direction A. In this case, the first direction A may be a longitudinal direction of the forming apparatus 10. The first direction A may be a lateral direction of the frame 10a.

Meanwhile, the pickup device 21 may include an adsorption member 22a configured to pick up the flat-surfaced member G arranged on the transfer mold 23.

The adsorption member 22a may move in a second direction B perpendicular to the first direction A. In this case, the second direction B may be a vertical direction. The adsorption member 22a may adsorb the flat-surfaced material G and transfer the adsorbed material G to the curved surface forming device 30. Although the adsorption member 22a acting as the air suction device may adsorb the flat-surfaced material G, and may fix and move the resultant material G for convenience of description, the scope or spirit of the present disclosure is not limited thereto. For example, the pickup device may include a hand device or the like to pick up the flat-surfaced material.

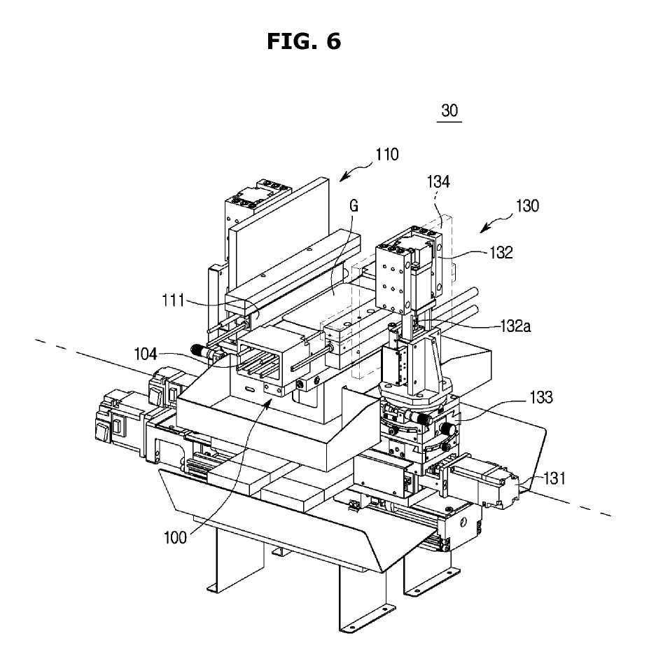

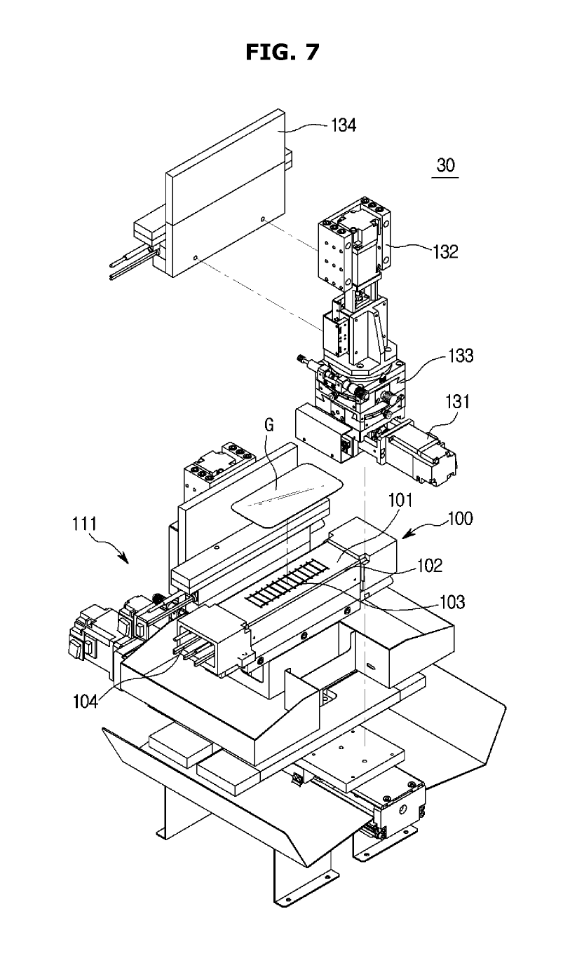

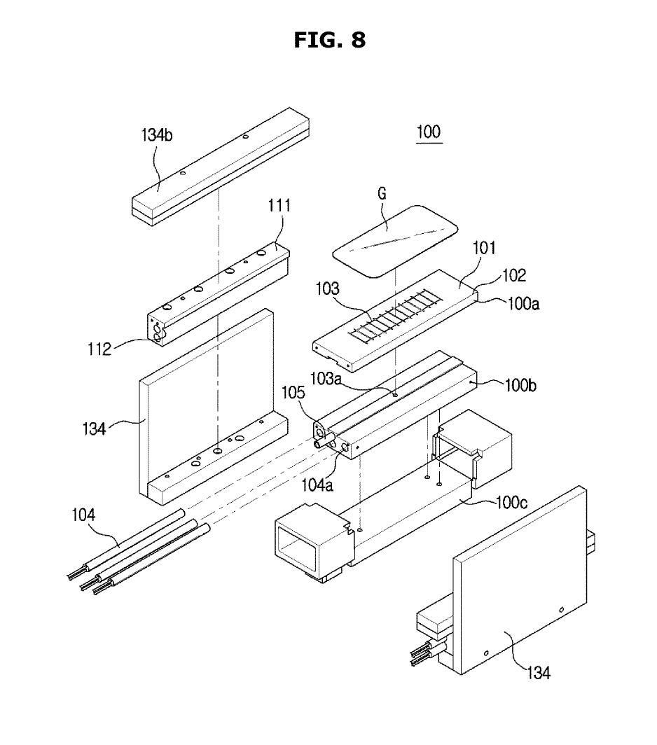

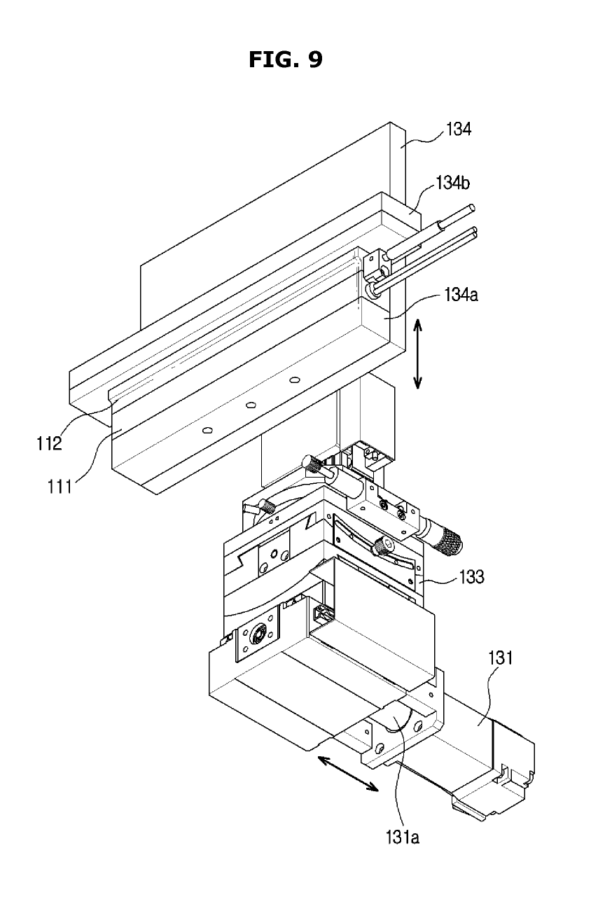

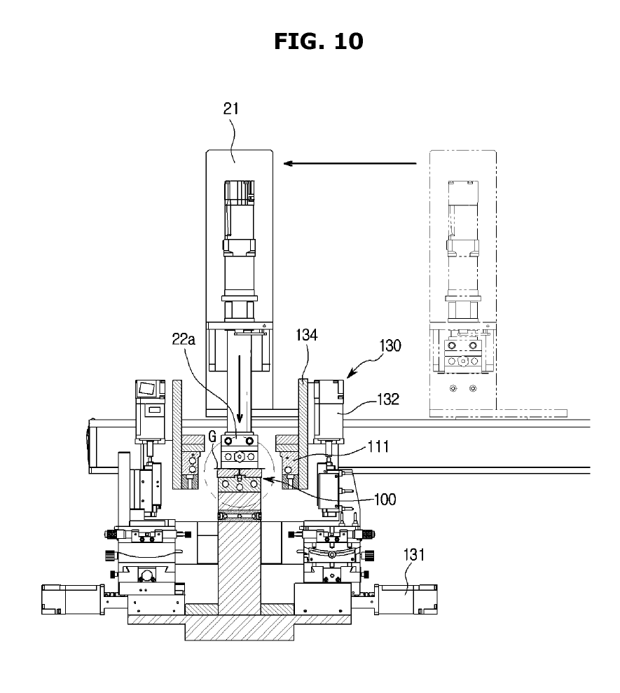

FIG. 6 is a perspective view illustrating a curved surface forming apparatus of the forming apparatus according to an embodiment of the present disclosure. FIG. 7 is a perspective view illustrating a forming mold and a jig unit of the curved surface forming apparatus according to an embodiment of the present disclosure. FIG. 8 is an exploded perspective view illustrating the forming mold and the jig unit according to an embodiment of the present disclosure. FIG. 9 is a structural view illustrating a driving device of the jig unit according to an embodiment of the present disclosure. FIG. 10 is a structural view illustrating the operation of a transfer portion according to an embodiment of the present disclosure.

Referring to FIGS. 6 to 10, the curved surface forming device 30 of the forming device 30 may be designed in a manner that at least some parts of the flat-surfaced material G supplied from the transfer device 20 have a curved shape.

The curved surface forming device 30 may include a forming mold 100 on which the material G is seated; a heating unit 120 to heat some parts of the material G; and a jig unit 110 to press the locally heated some parts of the material G in a manner that the some parts of the material G have a curved surface.

The flat-surfaced material G may be disposed on the forming mold 100. The forming mold 100 may be used for thermal deformation. Preheating, forming, and cooling of the forming mold 100 may be achieved through the one forming mold 100, such that at least some parts of the flat-surfaced material G may have a curved surface.

The forming mold 100 may include a forming block 100a, a heating block 100b located below the forming block 100a, and a support block 100c located below the heating block 100b.

The forming block 100a may include a support surface 101 on which the flat-surfaced material G supplied from the transfer device 20 is seated; and a forming surface 102 formed at both ends of the support surface 101.

A guide hole 103 guiding the material G may be formed at the support surface 101 of the forming block 100a in such a manner that the material G can be stably seated on the support surface 101. The guide hole 103 may pull the material G from the transfer device 20 using a predetermined vacuum pressure at a lower part of the material G so as to seat the material G thereon, or may be designed to perform air injection so as to take the completely formed material G out of the transfer device 20.

The guide hole 103 of the forming block 100a may be formed to communicate with the suction hole 103a of the heating bloc 100b.

On the other hand, the material G may include a first part that is subject to a formation process (hereinafter referred to as a formation surface) and a second part not subject to a formation process (hereinafter referred to as a non-formation surface). Referring to the formation surface and the non-formation surface, one part (not to be formed) contained in the glass 3 of FIG. 2 may be a flat surface portion 3a, and the other part (to be formed) contained in the glass 3 of FIG. 2 may have a curved surface portion 3b having a curvature at both ends of the flat surface portion 3a.

In this case, the curved surface portion 3b of the material G may be formed in a shape corresponding to the forming surface 102 of the forming block 100a.

The support surface 101 may be formed to have the size and width corresponding to those of the flat surface portion 3a in such a manner that the non-formation surface (i.e., the flat surface portion 3a) of the material G can be supported by the support surface 101.

A heater 104 configured to heat the forming mold 100 may be contained in the heating block 100b. A heater installation hole 104a in which the heater 104 is installed may be formed in the heating block 100b. One or more heater installation holes 104a may be formed.

In addition, an air suction tube 105 configured to communicate with the guide hole 103 of the forming block 100a is connected to the heating block 100b. The air suction tube 105 and the heater installation hole 104a may be spaced apart from each other by a predetermined distance such that the air suction tube 105 does not overlap the heater installation hole 104a.

Meanwhile, the heater 104 may be configured to preheat the material G at a predetermined temperature by heating the forming mold 100.

The forming mold 100 is preheated by the heating block 100b at a normal temperature such that the heated temperature increases to a predetermined temperature. That is, the forming mold 100 enters the standby mode in a preheated state. The material G is transferred by the transfer device 20, is seated on the preheated forming mold 100, and at the same time is preheated.

Some parts of the preheated material G may be heated by the heating unit 120 by laser light, and thus formed (i.e., molded). When the material G is heated by laser light, laser light absorbed from some the some forming surfaces is converted into thermal energy, such that heating is achieved. Thereafter, the heating is performed up to a predetermined temperature at which the above formation can be achieved, and the resultant material G is then pressed by the jig unit 110, so that the above formation can be achieved.

Meanwhile, the jig unit 110 may be configured to form a curved surface by pressing some parts of the material G heated by laser light.

The jig unit 110 may include a jig 111; and a driving device 130 configured to move the jig 111.

Two jigs 111 (i.e., one pair of jigs 111) may face each other while interposing the forming mold 100 therebetween.

Each jig 111 may include a curved surface shaped portion 112 which has a curved surface to form a curved surface on the material G by pressing some parts of the material G.

The curved surface shaped portion 112 may be provided in a semicircular shape recessed outward at an upper part of an inner lateral surface of the jig 111. The curved surface shaped portion 112 may be formed in a shape corresponding to the forming surface 102 of the forming block 100a.

Meanwhile, the jig 111 may be connected to the driving device 130 by a moving plate 134. The jig 111 may be supported by the installation plate 134a of the moving plate 134, and may be fixed by the fixed plate 134b.

The moving plate 134, while fixed to the driving device, may be transferred by the driving device 130.

The driving device 130 may include a first motor 131, a second motor 132 disposed perpendicular to the first motor 131, and a tilting portion 133.

The first motor 131 may move the moving plate 134 in the first direction A. A reference numeral 131a may denote a rotation shaft.

Meanwhile, the moving plate 134 connected to the driving device 130 may move in the first direction A by rotation of the first motor 131, and the jig 111 fixed to the moving plate 134 may also move in the first direction A.

The second motor 132 may move the moving plate 134 in the second direction B. A second cylinder 132a may vertically move in the second direction B by rotation of the second motor 132. When the second motor 132 rotates, the moving plate 134 connected to the driving device 130 may move in the second direction B, and the jig 111 fixed to the moving plate 134 may also move in the second direction B.

The moving plate 134 may be adjusted in the range of various angles under control of the first motor 131 and the second motor 132.

In addition, the tilting portion 133 may adjust the angle of the moving plate 134 such that the jig 111 presses some parts of the material G within the range of various angles, to form various curved surface shapes.

As can be seen from FIG. 10, the flat panel-shaped material G transferred to the forming mold 100 by the transfer device 20 may be disposed on the support surface 101 formed at an upper side of the forming block 100a of the forming mold 100.

In this case, the forming block 100a may be preheated by the heating block 100b at a predetermined temperature.

Therefore, at least some parts of the material G may be preheated and then enter the forming standby state.

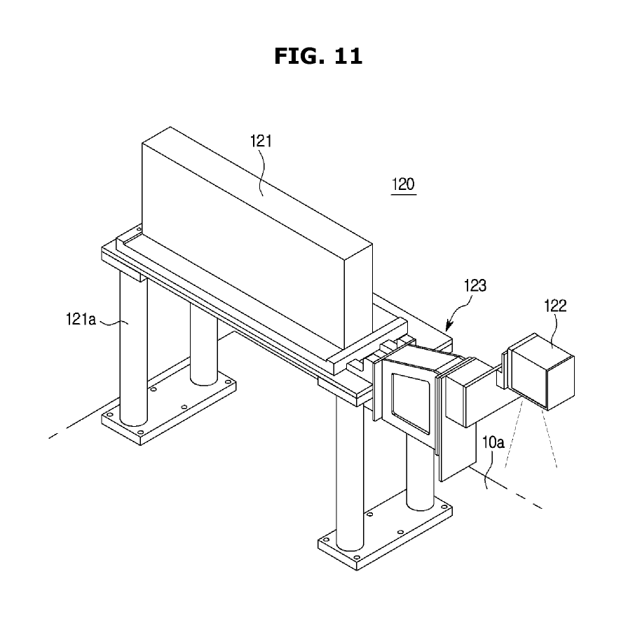

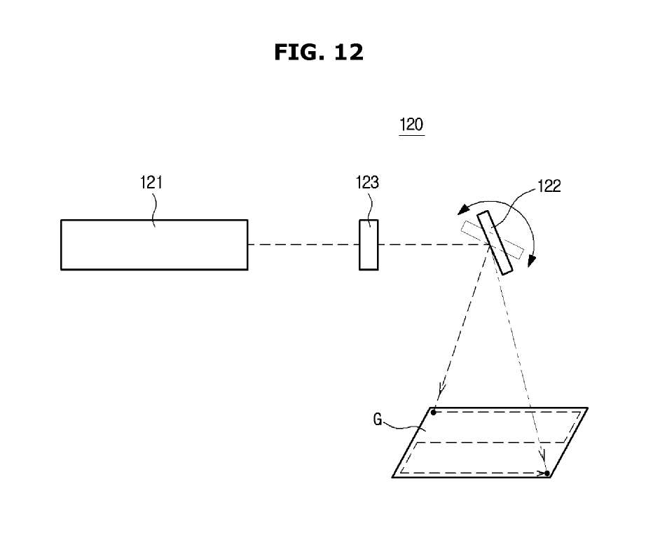

FIG. 11 is a perspective view illustrating a heating unit of a curved surface forming apparatus according to an embodiment of the present disclosure. FIG. 12 is a schematic diagram illustrating the operation of a heating unit according to an embodiment of the present disclosure.

Referring to FIGS. 11 and 12, the heating unit 120 of the curved surface forming device 30 may include a laser oscillator 121; and a scanner 122 to perform scan using laser light generated from the laser oscillator 121.

The heating unit 120 may be arranged over the frame 10a. The laser oscillator 121 may be installed at the support 121 a mounted to the frame 10a. The scanner 122 configured to emit laser light generated from the laser oscillator 121 to the material G in the forming mold 100 may be arranged over the forming mold 100.

The laser oscillator 121 may be provided to output laser light that is irradiated onto the material G disposed on the support surface 101 of the forming mold 100.

In this case, the laser oscillator 121 may be configured to output different wavelengths of laser light, for example, low-wavelength laser light, high-wavelength laser light, etc. The laser oscillator 121 may adjust laser light applied to the material G by selectively outputting laser light according to a material, thickness, and shape of the material G.

The laser oscillator 121 may quickly move Gaussian spot beam using the scanner 122 so that the Gaussian spot beam can be irradiated to the formation part of the material G.

The scanner 122 may be disposed at a predetermined position corresponding to the material G above the forming mold 100. A beam expanding telescope (BET) 124b may be disposed between the scanner 122 and the laser oscillator 121.

In addition, a diffraction optical system 123 may be disposed between the scanner 122 and the laser oscillator 121, such that laser light emitted from the laser oscillator 121 can be converted into spot beam having uniform intensity at the laser irradiation region.

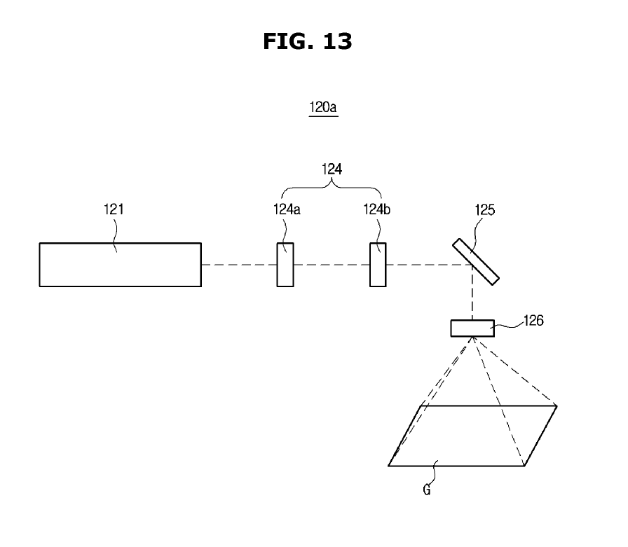

As can be seen from FIG. 13, the heating unit 120a may include a laser oscillator 121; and an optical portion 124 configured to emit laser light generated from the laser oscillator 121 to at least some parts of the material G.

The optical portion 124 may include a diffractive optical element (DOE) 124a and the beam expanding telescope 124b. The optical portion 124 may further include a mirror 125 to vertically reflect laser light generated from the laser oscillator 121; and a lens 126 allowing the laser light reflected from the mirror 125 to be irradiated onto the material G.

Therefore, the heating unit 120a may convert the Gaussian spot beam into linear beam having uniform intensity in an irradiation region, such that the Gaussian spot beam can be irradiated onto the entirety of a desired formation part of the material G.

Meanwhile, assuming that laser light is irradiated as described above, when some parts of the material G is heated and reaches a specific temperature at which formation is possible, the parts of the material G are pressed and then formed.

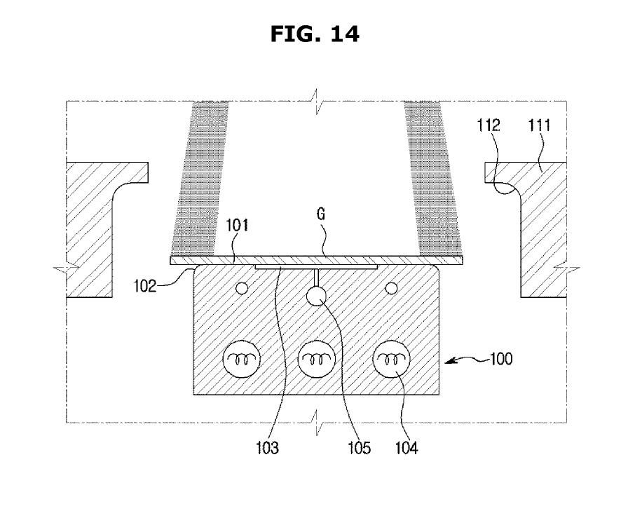

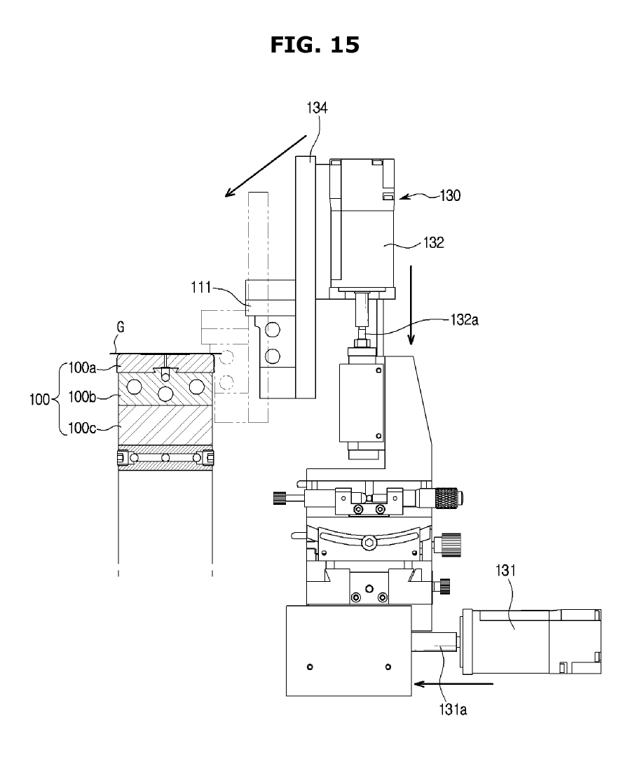

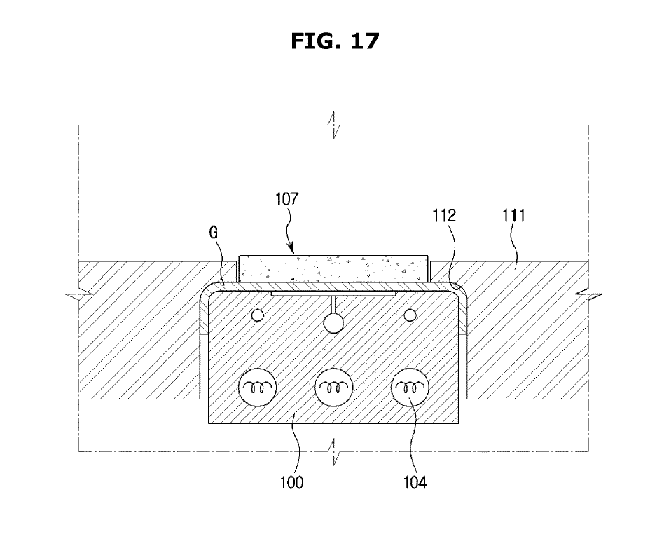

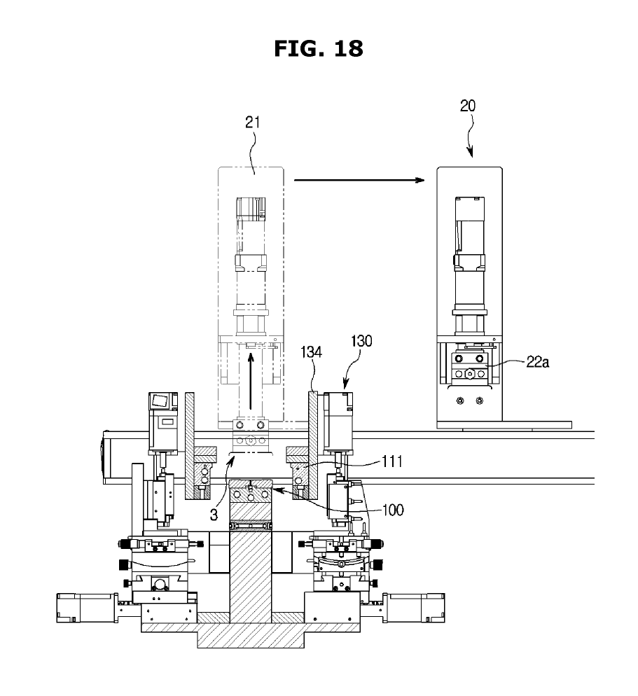

FIG. 13 is a schematic diagram illustrating the operation of a heating unit according to another embodiment of the present disclosure. FIGS. 14 to 17 are schematic diagrams illustrating forming procedures of the curved surface forming apparatus according to an embodiment of the present disclosure. FIG. 18 is a schematic diagram illustrating the operation of a transfer device configured to discharge a curved glass for use in the curved surface forming apparatus according to an embodiment of the present disclosure.

Referring to FIGS. 13 to 18, assuming that the flat panel-shaped material G is arranged on the forming mold 100 preheated with a predetermined temperature by the transfer device 20, laser light is irradiated by the heating unit 120.

In this case, laser light may be intensively irradiated onto a target part (to be formed) of the material G.

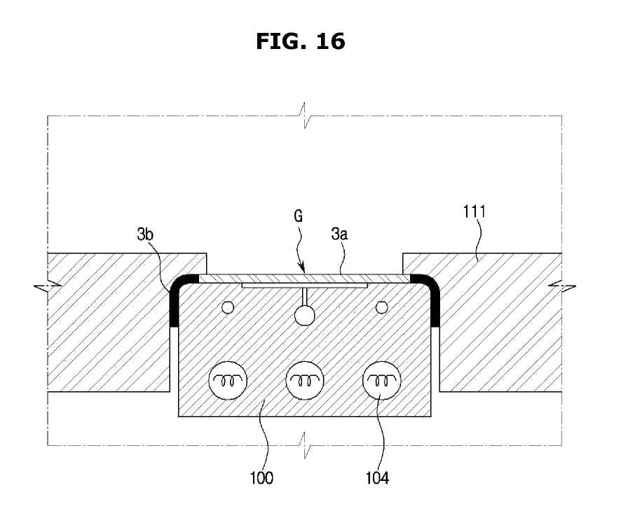

The material G heated by laser irradiation may be pressed by the jig 111 of the jig unit 110 to form a curved shape (as shown in FIG. 16).

The jig 111 may be transferred by the driving device 130 and then press some parts of the material G. The jig 111 may adjust the moving distance and angle using the first motor 131 and the second motor 132 of the driving device 130. Although the embodiment has exemplarily disclosed that the jig 111 is configured to press the material G at the angle of 45°, the scope or spirit of the present disclosure is not limited thereto. For example, the moving angle and distance of the jig 111 may be adjusted by the driving device.

The material G pressed by the jig 111 may form a curved shape by the forming surface 102 of the forming block 100a and the curved surface shaped portion 112 of the jig 111.

A warming member 107 is disposed on the completely formed material G.

The warming member 107 may allow the material G to be kept at a predetermined temperature for a predetermined period of time. The warming member 107 may include one of an insulation material and a heating block.

Meanwhile, the completely formed and cooled glass 3 may be discharged by the transfer device 20. A method for cooling the completely formed material G according to the embodiment may include allowing the completely formed material G to be kept at a predetermined temperature for a predetermined period of time.

The adsorption member 22a of the transfer device 20 may adsorb and move the glass 3 disposed on the forming block 100a, and then discharge the glass 3.

As described above, the curved surface forming device 30 can simultaneously perform preheating, forming, and cooling (temperature maintenance) using the single forming mold 100, such that product costs and facility investment cost are reduced, resulting in reduction of total operating expenses.

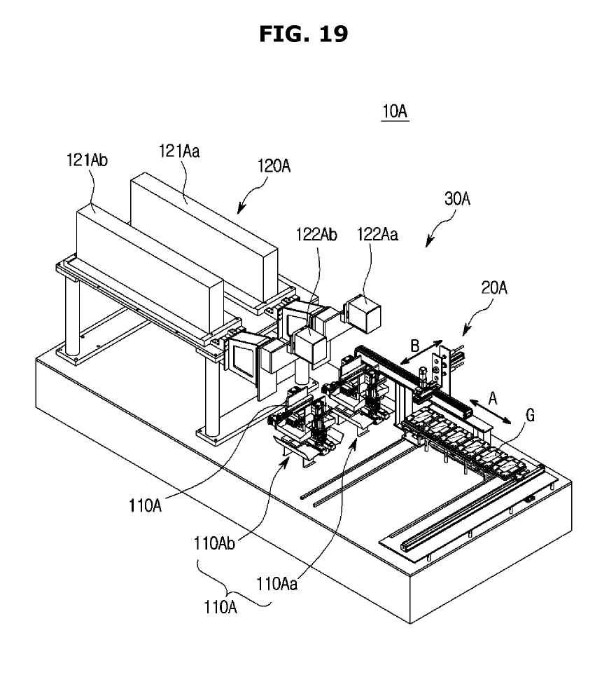

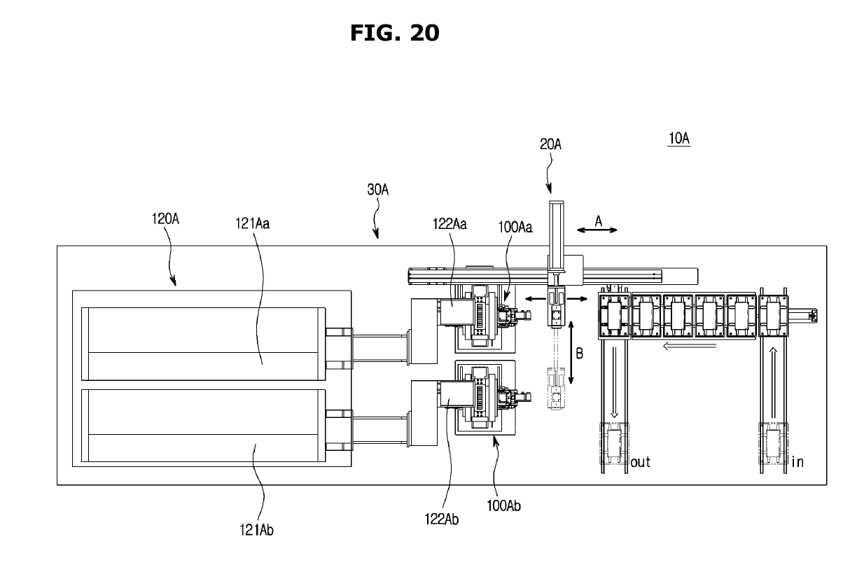

FIG. 19 is a perspective view illustrating a forming apparatus according to another embodiment of the present disclosure, and FIG. 20 is a front view illustrating the forming apparatus according to another embodiment of the present disclosure.

Referring to FIGS. 19 and 20, a forming apparatus 10A may include a transfer device 20A to transfer material G; and a curved surface forming device 30A to form a curved surface on the material G transferred by the transfer device 20A.

In this case, one transfer device 20A may be used, plural forming molds 100A, plural heating units 120A, and plural jig unit 110A may be used to construct the curved surface forming device 30A.

The curved surface forming device 30A may include the forming mold 100A on which the material G is seated; the heating unit 120A configured to heat at least some parts of the material G; and the jig unit 110A to press the material G such that the locally heated parts of the material G is formed in a curved surface.

The material G introduced by the transfer device 20A is formed (molded) and cooled by the curved surface forming device 30A and thus manufactured as a completed product formed of the glass G having a curved surface, and then is discharged by the transfer device 20A.

The transfer device 20A may transfer the material G to each of two forming molds (100Aa, 100Ab) such that formation is achieved. When such formation is completed, the material G is discharged.

Although the embodiment has exemplarily disclosed that two curved surface forming devices are arranged in one transfer device for convenience of description and better understanding of the present disclosure, the scope or spirit of the present disclosure is not limited thereto. For example, two or more curved surface forming devices may be formed.

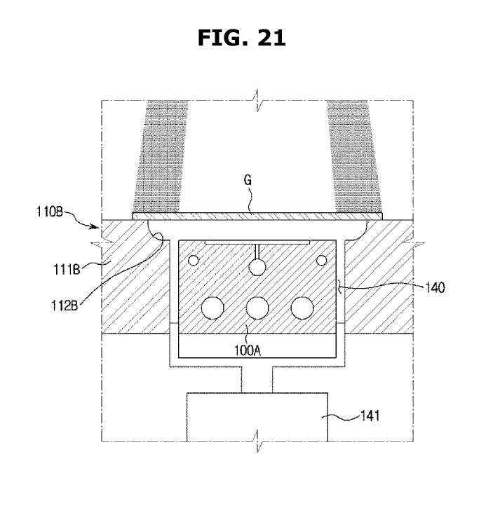

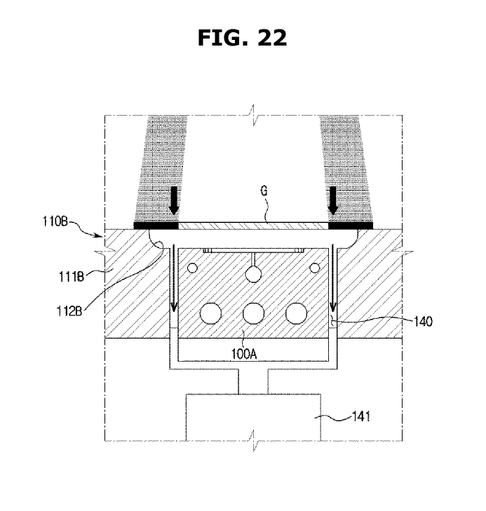

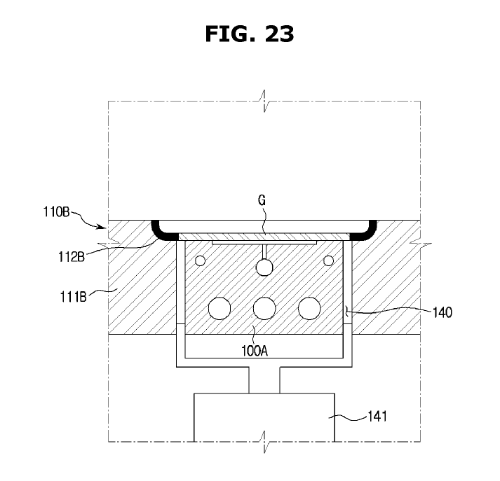

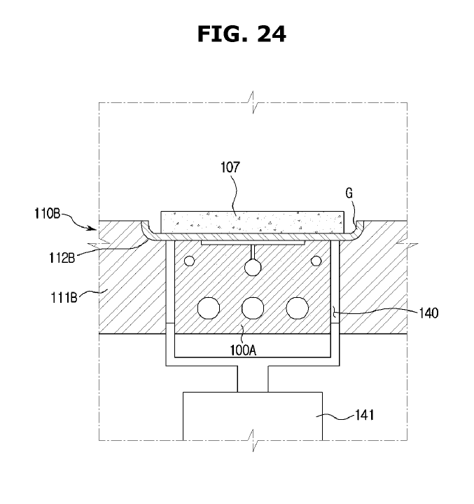

FIGS. 21 to 24 are conceptual diagrams illustrating the forming operations performed by a jig unit of the curved surface forming apparatus according to another embodiment of the present disclosure.

Referring to FIGS. 21 to 24, a jig unit 110B may be configured to form a curved surface by pressing at least some parts of the material G disposed on the forming mold 100A.

The jig unit 110B may include a jig 111B in which a curved surface shaped portion 112B having a curved surface shape is formed.

The curved surface shaped portion 112B of the jig 111B may be formed coplanar with a top surface of the forming mold 100A. The curved surface shaped portion 112B includes a curved surface shape that is recessed outward.

Meanwhile, a suction passage 140 configured to press the material G at a vacuum state may be formed between the jig 111B and the forming mold 100A.

The suction passage 140 may be connected to a pneumatic device 141 located below the forming mold 100A.

Therefore, assuming that the material G is heated by laser irradiation and at the same time the pneumatic device 141 is driven such that air is suctioned through the suction passage 140, a forming space S between the jig 111B and the forming mold 100A becomes a vacuum state, and the heated part of the material G may be seated on the forming mold 100A and the curved surface shaped portion 112B of the jig 111B, resulting in formation of the material G.

Thereafter, a warming member 107 is disposed on the completely formed material G, such that the material G can be maintained at a predetermined temperature.

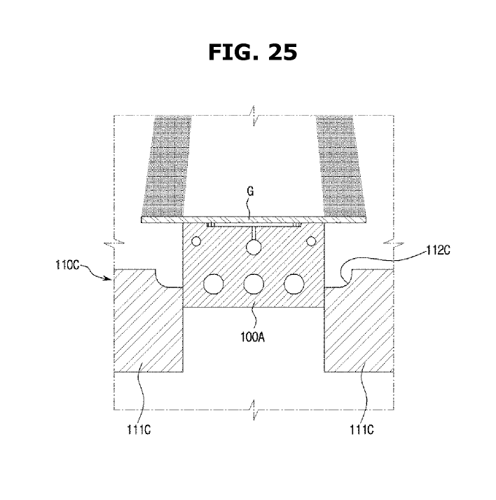

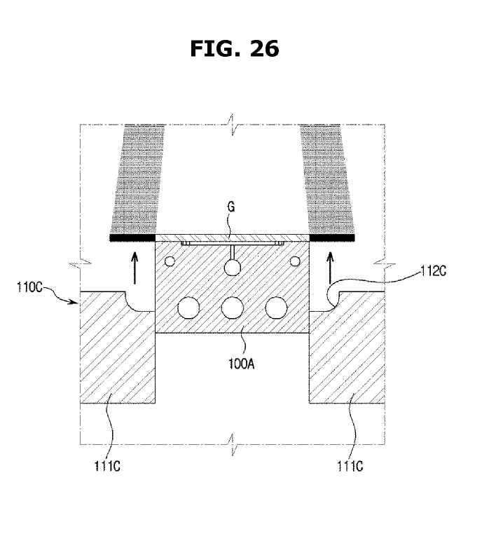

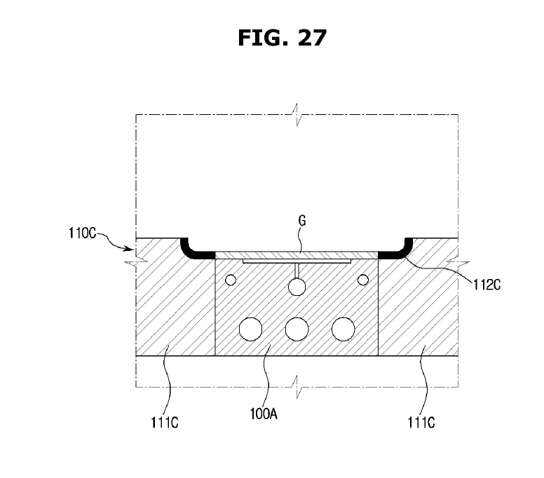

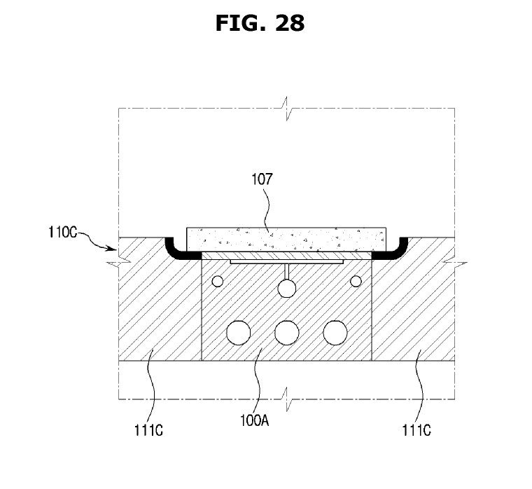

FIGS. 25 to 28 are schematic diagrams illustrating the forming operations performed by a jig unit 110C according to still another embodiment of the present disclosure.

Referring to FIGS. 25 to 28, a jig unit 110C may press some parts of the flat panel shaped material G disposed on the forming mold 100A in the upward direction, to form a curved shape.

The jig unit 110C may include a jig 111C in which a curved surface shaped portion 112C having a curved surface shape is formed.

The curved surface shaped portion 112C of the jig 111C may be configured to form a curved surface shape collinear with a top surface of the forming mold 100A.

Therefore, assuming that laser light is irradiated onto the material G disposed on the forming mold 100A, the jig 111C moves upward so that it presses the formation part of the material G. The material G heated by laser light is formed to have a curved shape by the curved surface shaped portion 112C of the jig 111C.

A warming member 107 is disposed on the completely formed material G, such that the material G can be maintained at a predetermined temperature for a predetermined period of time.

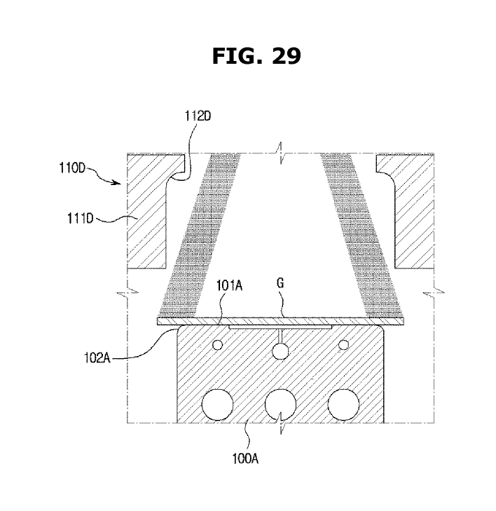

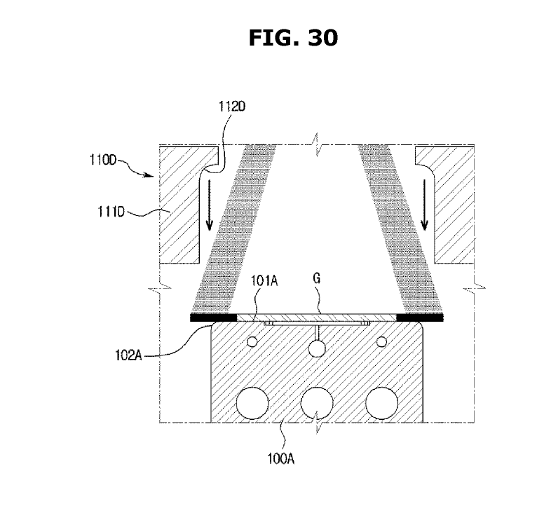

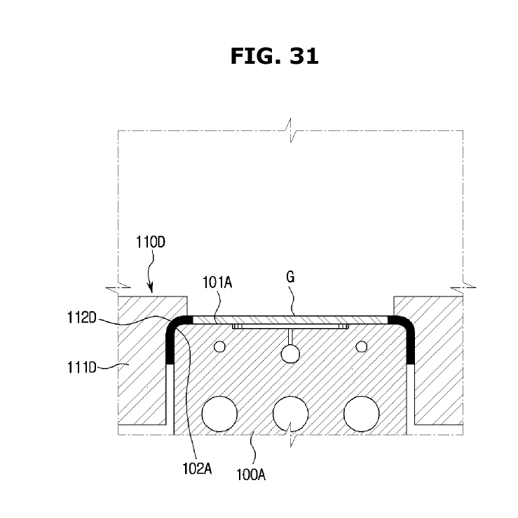

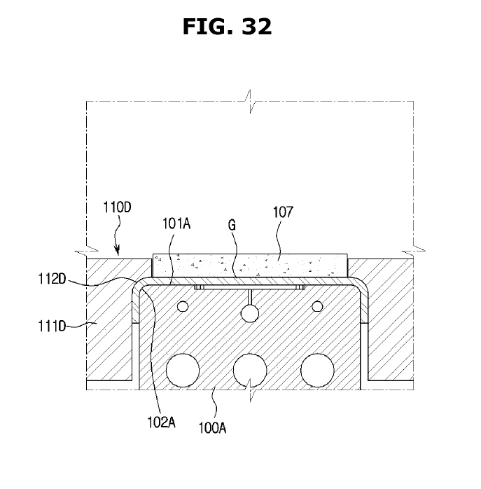

FIGS. 29 to 32 are schematic diagrams illustrating the forming operations performed by a jig unit 110D according to still another embodiment of the present disclosure.

Referring to FIGS. 29 to 32, a jig unit 110D may press some parts of the flat panel-shaped material G disposed on the forming mold 100A in the downward direction, to form a curved shape.

The jig unit 110D may include a jig 111D in which a curved surface shaped portion 112D 112C having a curved surface shape is formed.

The forming mold 100A may include a support surface 101A disposed at an upper surface thereof in a manner that material G is seated on the support surface 101A; and a forming surface 102A connected to the support surface 101A to be supported when forming a curved surface on the material G.

Therefore, assuming that laser is irradiated onto the material G disposed on the support surface 101A of the forming mold 100A, the jig 111D moves downward to press the formation part of the material G.

In this case, the material G heated by laser light may be formed to have a curved shape by the forming surface 102A of the forming mold 100A and the curved surface shaped portion 112D of the jig 111D.

In the meantime, the warming member 107 is disposed on the completely formed material G, such that the material G is maintained at a predetermined temperature for a predetermined period of time.

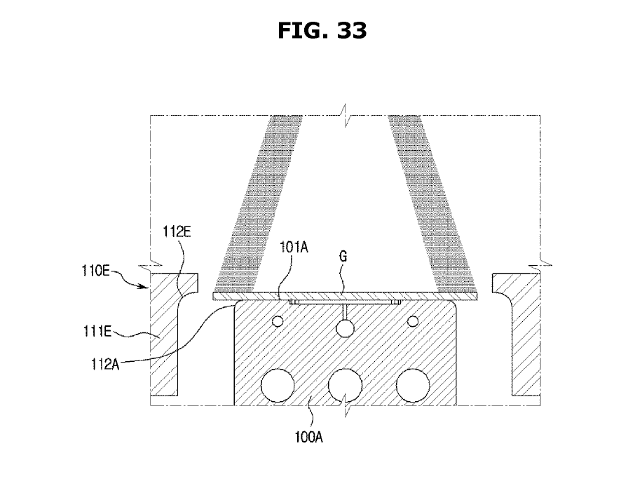

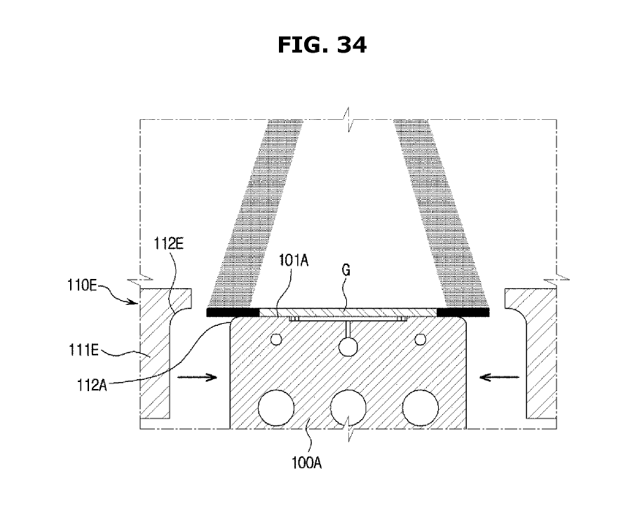

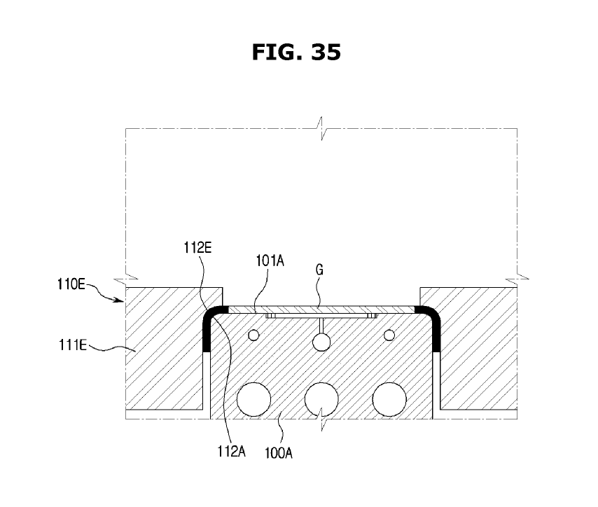

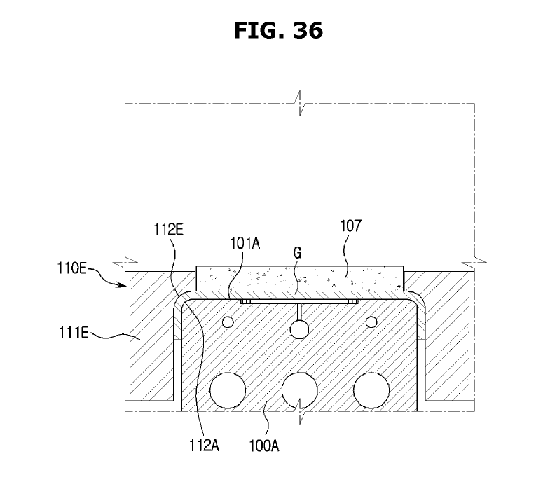

FIGS. 33 to 36 are schematic diagrams illustrating the forming operations performed by a jig unit 110E according to still another embodiment of the present disclosure.

Referring to FIGS. 33 to 36, a jig unit 110E may horizontally press some parts of the flat-surfaced material G disposed on the forming mold 100A, to form a curved shape.

The jig unit 110E may include a jig 111E in which a curved surface shaped portion 112E having a curved surface shape is formed.

The forming mold 100A may include a support surface 101A disposed at an upper surface thereof in a manner that the material G is disposed on the support surface 101A; and a forming surface 102A connected to the support surface 101A to be supported when forming a curved surface on the material G.

Therefore, assuming that laser light is irradiated onto the material G disposed on the support surface 101A of the forming mold 100A, the jig 111E moves horizontally to press the formation part of the material G.

In this case, the material G heated by laser light may be formed to have a curved shape by the forming surface 102A of the forming mold 100A and the curved surface shaped portion 112E of the jig 111E.

Meanwhile, the warming member 107 is disposed over the completely formed material G, such that the material G can be maintained at a predetermined temperature for a predetermined period of time.

As is apparent from the above description, the embodiments of the present disclosure form a curved surface by selectively heating only a formation part of a flat panel glass using laser without increasing the temperature of a non-formation part, so that contamination of the non-formation part is prevented, product costs, facility investment cost and total operating expenses can be reduced.

In addition, the embodiments of the present disclosure can improve energy efficiency and can simplify the forming equipment structure.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A forming apparatus comprising:
a transfer device configured to transfer material having a flat panel shape; and
a curved surface forming device configured to form at least one part of the material in a curved surface,
wherein the curved surface forming device includes:
a forming mold on which the material is seated;
a heating unit configured to heat the at least one part of the material by laser light; and
a jig unit configured to form the at least one part of the material heated by laser light in a curved surface.

2. The forming apparatus according to claim 1, wherein the material includes one of glass and sapphire glass.

3. The forming apparatus according to claim 1, wherein the forming mold is provided to allow the material to be seated thereon to be subject to preheating, forming, and cooling.

4. The forming apparatus according to claim 1, wherein the forming mold includes a heater configured to preheat the material.

5. The forming apparatus according to claim 1, wherein the curved surface forming device further includes:
a warming member disposed on the forming mold, and configured to maintain the material having been subject to the forming at a predetermined temperature for a predetermined period of time.

6. The forming apparatus according to claim 5, wherein the warming member includes one of an insulation material and a heating block.

7. The forming apparatus according to claim 1, wherein the forming mold includes:
a support surface on which the material is seated; and
a forming surface provided at both ends of the support surface.

8. The forming apparatus according to claim 1, wherein the jig unit includes:
a jig which includes a curved surface-shaped portion configured to form a curved surface on the at least one part of the material by pressing the at least one part of the material; and
a driving device configured to move the jig.

9. The forming apparatus according to claim 8, wherein the jig includes one pair of jigs which face each other.

10. The forming apparatus according to claim 8, wherein the driving device includes:
a first motor configured to move the jig in a first direction;
a second motor configured to move the jig in a second direction perpendicular to the first direction; and
a tilting portion configured to tilt the jig.

11. The forming apparatus according to claim 8, further comprising:
a moving plate allowing the jig to be connected to the driving device so that the jig is movable.

12. The forming apparatus according to claim 1, wherein the heating unit includes:
a laser oscillator; and
an optical portion configured to irradiate laser light generated from the laser oscillator onto the at least one part of the material.

13. The forming apparatus according to claim 12, wherein the optical portion includes:
a mirror configured to reflect laser light generated from the laser oscillator; and
a lens allowing the laser light reflected from the mirror to be irradiated onto the material.

14. The forming apparatus according to claim 12, wherein the heating unit further includes:
a scanner configured to perform scan using the laser light generated from the laser oscillator.

15. The forming apparatus according to claim 1, wherein the curved surface forming device further includes:
a pneumatic device configured to press the at least one part of the laser-heated material using air, or configured to generate a vacuum pressure.

16. A forming method comprising:
seating material having a flat-panel shape onto a forming mold by transferring the material using a transfer unit;
preheating the material seated on the forming mold;
irradiating laser light to a part of the preheated material;
applying external force to the part of the material onto which the laser light is irradiated; and
maintaining a temperature of the material using a warming member.

17. The forming method according to claim 16, wherein the material includes one of glass and sapphire glass.

18. The forming method according to claim 16, wherein the warming member includes one of an insulation material and a heating block.

19. The forming method according to claim 16, wherein the forming mold includes:
at least one flow passage and a pneumatic device which is connected to the at least one flow passage,
wherein the pneumatic device allows a curved shape to be formed on the material by dead weight while adsorbing the material.

20. The forming method according to claim 16, further comprising:
preheating another part of the material by a heater provided in the forming mold.
